(19) United States
(12) Patent Application Publication
(10) Pub. No.: US 2019/0043143 A1
(43) Pub. Date: Feb. 7, 2019

(54) METHOD AND SYSTEM FOR PROVIDING COOKED MEALS TO A MEAL SEEKER IN A DEFINED GEOGRAPHICAL LOCATION

(71) Applicant: Cook4U Technologies, Inc., Miami, FL (US)

(72) Inventors: Ricardo CAMACHO, Coral Gables, FL (US); Ruben Llavona ALVAREZ, London (GB)

(21) Appl. No.: 16/156,451

(22) Filed: Oct. 10, 2018

Related U.S. Application Data
(63) Continuation of application No. PCT/US17/26756, filed on Apr. 10, 2017.
(60) Provisional application No. 62/320,797, filed on Apr. 11, 2016.

(51) Int. Cl. G06Q 50/12; G06Q 30/06

(52) U.S. Cl. CPC G06Q 50/12; G06Q 30/0641; G06Q 30/0633

(57) ABSTRACT

Disclosed herein is a method for providing a cooked meal to a meal seeker. The method comprises the steps of receiving, at a remote server, a meal request from a meal seeker, where the meal request is sent via an interface on a networked device and comprises one or more food preferences; delivering, from the remote server, one of more available meal options to the meal seeker via the interface on the networked device; receiving, at the remote server, a selection among the one of more available meal options from the meal seeker; communicating the selected meal option to a meal provider of the selected meal option; and sending a confirmation to the meal seeker with instructions for obtaining the selected meal option.

### CROSS REFERENCE TO RELATED CASES

This application claims priority under 35 U.S.C. § 120 to and is a continuation of PCT international patent application PCT/US17/26756 filed 10 Apr. 2017, which claims priority from U.S. Provisional Application 62/320,797 filed 11 Apr. 2016, which are hereby incorporated by reference in their entirety herein.

### FIELD OF THE INVENTION

The invention disclosed herein generally relates to methods and systems for providing and receiving services or products in a local collaborative economy. In particular, the providing and receiving service disclosed herein are in the context of food.

### BACKGROUND

Time and resource distributions often do not match the demands for such. For example, a working professional hankering for home-cooked meals as alternatives to restaurant take-outs does not have the time to prepare or even the time to purchase the necessary ingredients for preparing such meals. On the other hand, a stay-at-home mom with children in school has some time for extra meal preparation during the day but does not have the time to qualify for a regular job to generate financial income.

What is needed are methods and systems for supporting a collaborative economy that brings together a demand for a specific service (e.g., food) and the possible supple of that specific service.

### SUMMARY OF THE INVENTION

In one aspect, disclosed herein is a method for providing a cooked meal to a meal seeker. The method comprises the steps of receiving, at a remote server, a meal request from a meal seeker, where the meal request is sent via an interface on a networked device and comprises one or more food preferences; delivering, from the remote server, one of more available meal options to the meal seeker via the interface on the networked device; receiving, at the remote server, a selection among the one of more available meal options from the meal seeker; communicating the selected meal option to a meal provider of the selected meal option; and sending a confirmation to the meal seeker with instructions for obtaining the selected meal option.

In some embodiments, the one or more food preferences are selected from the group consisting of location, cuisine type, price, time preference, take-out option, dining option, and food allergy information. In some embodiments, the location information is determined automatically by a GPS receiver on the networked device or based on the device's association with a wireless or cellular network.

In some embodiments, the one or more available meal options are generated based on the meal request from the meal seeker.

In some embodiments, the meal request is created using a menu in the interface on the networked device.

In some embodiments, the meal seeker has a meal seeker profile stored on the remote server.

In some embodiments, the meal provider is within a predefined physical vicinity to the meal seeker.

In some embodiments, the meal provider has a meal provider profile stored on the remote server.

In some embodiments, the remote server includes one or more selected from the group consisting of a database of meal options, a database of meal seekers, and a database of meal providers.

In some embodiments, the one or more available meal options are ranked based on one selected from the group consisting of physical vicinity to the meal seeker, price, and reviews of a meal provider.

In some embodiments, the instructions comprise an optional invitation to dine with the meal provider.

In some embodiments, the networked device is selected from the group consisting of a desktop computer, a laptop computer, a cellular phone, a personal digital assistant (PDA), an iPod, a tablet, a mobile device equipped with a network device, a smart phone, a pager, a television, a media player, a digital video recorder (DVR), and any other networked devices.

In one aspect, provided herein is a method for obtaining a cooked meal from a meal provider. The method comprises the steps of sending, via an interface on a networked device and to a remote server, a meal request, where the meal request comprises one or more food preferences; receiving, via the interface and from the remote server, one or more available meal options; sending, via the interface and to the remote server, a selected meal option from the one or more available meal options; and receiving, via the interface and from the remote server, a confirmation including instructions for obtaining the selected meal option.

In some embodiments, the method further comprises a step of selecting, via the interface, a meal option among the one or more available meal options.

In some embodiments, the one or more food preferences are selected from the group consisting of location, cuisine type, price, time preference, take-out option, dining option, and food allergy information.

In some embodiments, the meal request is created using a menu in the interface on the networked device.

In some embodiments, the meal request is created using a menu in response to a communication received from the remote server via the interface on the networked device.

In some embodiments, the meal seeker has a meal seeker profile stored on the remote server.

In some embodiments, the remote server includes a database of meal options.

In some embodiments, the one or more available meal options are ranked based on one selected from the group consisting of physical vicinity to the meal seeker, price, and reviews of a meal provider.

In some embodiments, the networked device is selected from the group consisting of a desktop computer, a laptop computer, a cellular phone, a personal digital assistant (PDA), an iPod, a tablet, a mobile device equipped with a network device, a smart phone, a pager, a television, a media player, a digital video recorder (DVR), and any other networked devices.

In one aspect, provided herein is a method of providing a cooked meal to a meal seeker. The method comprises the steps of receiving, via an interface on a networked device and from a remote server, a meal request, wherein the meal request specifies one or more food preferences; sending, via the interface and to the remote server, a communication, where the communication includes a price; and receiving, via the interface and from the remote server, a confirmation whether the communication is accepted by the meal seeker.

In some embodiments, the communication further comprises an optional dining invitation to the meal seeker.

In some embodiments, the one or more food preferences are selected from the group consisting of location, cuisine type, price, time preference, take-out option, dining option, and food allergy information.

It will be understood that the embodiments disclosed herein can be used in any combinations when applicable.

### BRIEF DESCRIPTION OF THE DRAWINGS

Those of skill in the art will understand that the drawings, described below, are for illustrative purposes only. The drawings are not intended to limit the scope of the present teachings in any way.

FIG. 1 illustrates an exemplary embodiment for implementing the methods disclosed herein.

FIG. 2A illustrates an exemplary process.

FIG. 2B illustrates an exemplary embodiment.

FIG. 2C illustrates an exemplary embodiment.

FIG. 3 illustrates an exemplary embodiment.

FIG. 4 illustrates an exemplary embodiment.

FIG. 5A illustrates an exemplary embodiment.

FIG. 5B illustrates an exemplary embodiment.

FIG. 5C illustrates an exemplary embodiment.

FIG. 5D illustrates an exemplary embodiment.

### DETAILED DESCRIPTION OF THE INVENTION

Unless otherwise noted, terms are to be understood according to conventional usage by those of ordinary skill in the relevant art.

The methods and systems disclosed herein can be applied to any type of collaborative economy that brings together a demand for a specific service or product and possible sources of supply for the specific service or product. Provision of cooked meals is used here as an example; however, one of skill in the art would understand that any service and/or product that fits into the collaborative economy model will be within the scope of the invention, including but not limited to laundry/dry clean service, cleaning service, gardening service, handyman service, home grown fruits, and etc.

The particular example of collaborative economy disclosed herein brings together demands and sources of cooked meals. Anybody who has ever had a demand for a cooked meal can be on the receiving end of this particular service/product. A meal seeker, or a foodie, can be anyone who has ever experience any of the following:
Didn't have time to cook before leaving for work?
Tired of eating alone at your office?
Miss homemade food?
Tired of eating always the same?
Waiters already know your name at the nearest restaurant?
Tired of eating a cold sandwich at the library?
Not enough options for your eating restrictions in your area?
Tired of eating again at a fast food joint?
Tired eating a pizza again at your dorm because no other options are available?

Anyone who cooks can be at the supply end to provide service/product to a meal seeker. A meal provider or a cook, can be motivated by any of the following:
Do you need some extra income?
Do you like to cook or are you good at it?
Tired of throwing away food?
You've cooked for the whole family and nobody is coming?
Bored of cooking just for you?
You have recipes that you would like others to enjoy?

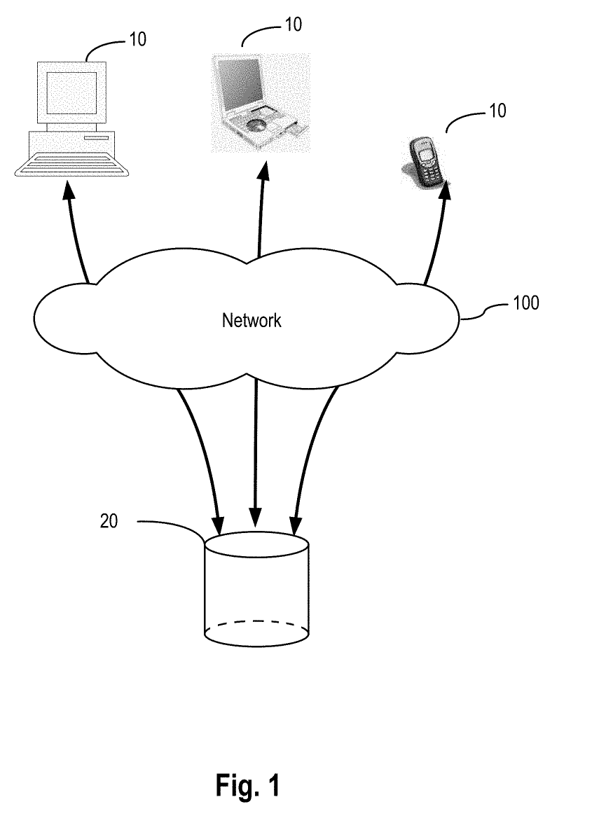

In one aspect, provided herein is a method for providing a meal cooked by a meal provider to a meal seeker. An exemplary system is depicted in FIG. 1. In the exemplary system, meal provides and meal seekers do not directly communicate with each other. Instead, they each use networked devices 10 to communicate with a remote server 20 via network 100. Exemplary networked devices include but are not limited to a desktop computer, a laptop computer, a cellular phone, a personal digital assistant (PDA), an iPod, a tablet, a mobile device equipped with a network device, a smart phone, a pager, a television, a media player, a digital video recorder (DVR), or any other networked devices.

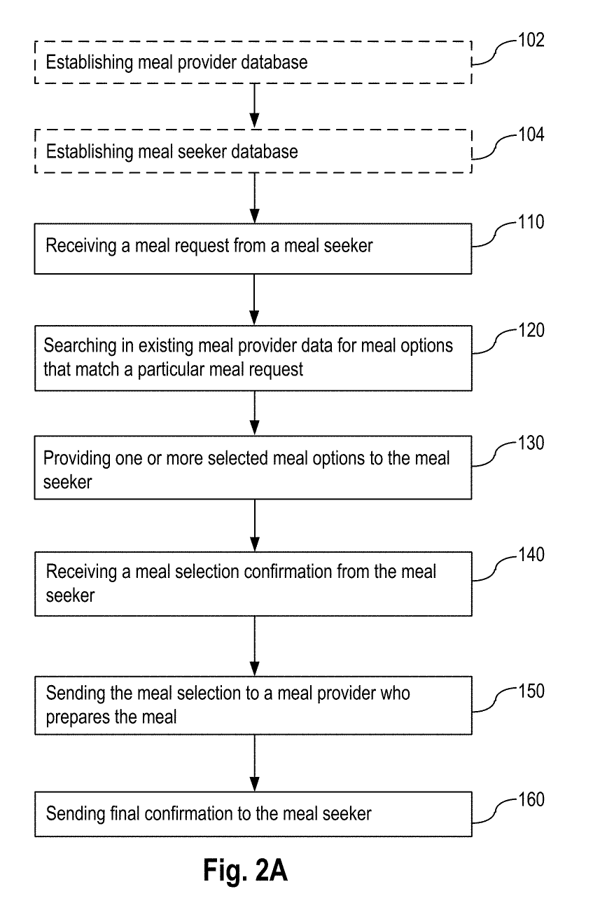

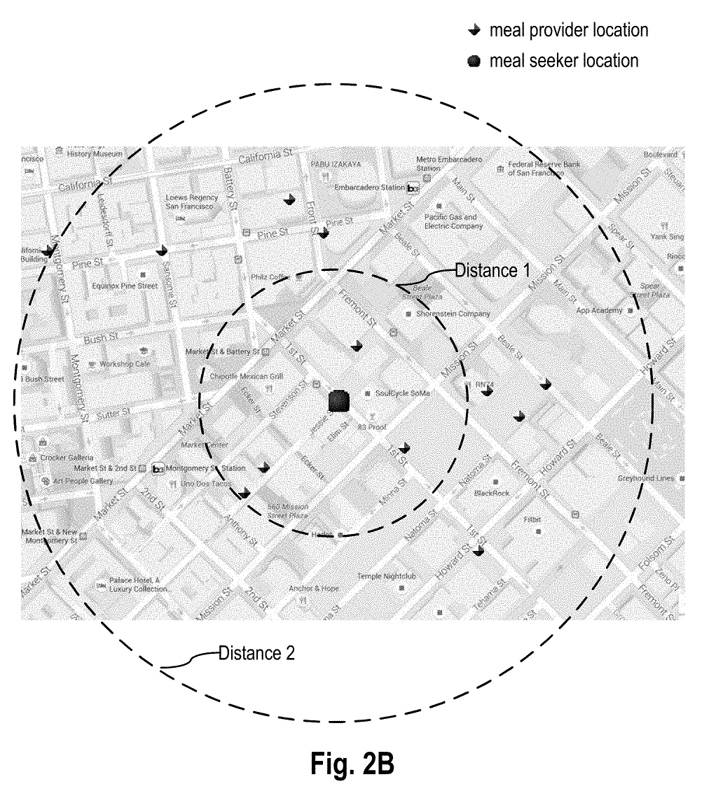

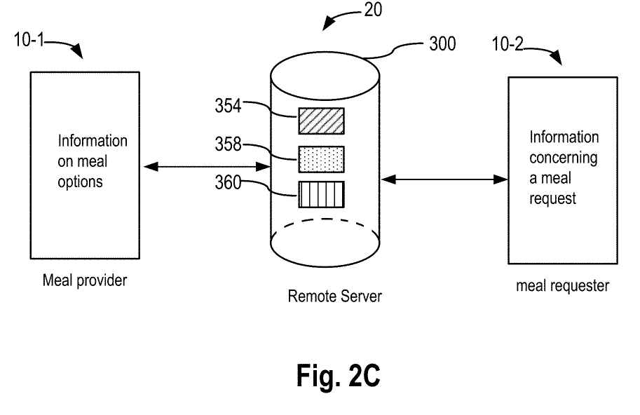

An exemplary process is depicted in FIG. 2A.

At step 110, a meal seeker sends a meal request to a remote server, using, for example, an interface on a mobile app on a cell phone. A meal request can include one or more food or food related preferences. In some embodiments, the meal request can be a specific dish or several dishes; for example, sweet and sour spareribs, stir-fry string beans and spinach salad. In some embodiments, the meal request can be a more general guideline of a type of cuisine with a general main ingredient; for example, duck leg cooked French style. In some embodiments, the meal request specifies that the cooked meal must be within a certain physical area, close to where the meal seeker is located. In some embodiments, the meal request specifies when the meal should be ready for pick-up. In some embodiments, the meal request includes food allergy information of the meal seeker. In some embodiments, a meal seeker can specify a location where he or she would like to pick up the food. The specified location can be the place the meal seeker is currently at or a place where the meal seeker will be at a later time. In some embodiments, the geographic location of the meal seeker will be determined automatically using, for example, a GPS location enabled device such as a smart phone. Additionally, the location of a meal seeker can be determined automatically based on affiliations with a wireless network, and/or a cellular network.

At step 120, once the meal request is received at the remote server, the system launches a search of existing available meal options by matching or substantially matching criteria from the meal request with description of such existing available meal options. Available meal options that meet the criteria of the meal request will be combined to form a list of available meal options. The list will be sent to the meal seeker in a ranked or non-ranked format. In some embodiments, the available meal options will be ranked according to how close they are to the location of the meal seeker. In some embodiments, the available meal options will be ranked according to how close match the cuisine requirements. In some embodiments, the available meal options will be mapped by their locations. In some embodiments, the available meal options will be ranked by their prices. In some embodiments, the available meal options will be ranked by their quantities. In some embodiments, the available meal options will be ranked by reviews of the providers of such meal options. In some embodiments, a meal seeker can prioritize his or her food or food-related preferences. For example, if location is the top priority, only meal options within a specified distance will be presented to the meal seeker. If cuisine type is the top priority, only the specified cuisine types will be presented to the meal seeker.

In some embodiments, when no existing meal options match or substantially match a particular meal request, the remote server can send a system request to one or more meal providers to solicit availability for make a meal according to the meal request. In some embodiments, the meal provider who responds first to the system request will be selected. In some embodiments, the meal provider who responds and is closest to the meal seeker will be selected, depending on how strictly the meal seeker limit travel time for retrieving the cooked meal.

At step 130, once available meal options that match or substantial match the meal request are identified, they are sent to the meal seeker. As disclosed above, the result can be sent as a ranked list based on priority or priorities set by the meal seeker.

FIG. 2B illustrates exemplary results of available meal options. The location of the meal seeker is highlighted at the center of the concentric circles (corresponding to distance 1 and distance 2, respectively) in the map. It will be understood that searches based on a short distance (e.g., distance 1) will lead to fewer options of meal providers, than a search based on a longer distance (e.g., distance 2). Locations of available meal providers are also provided, for example, based on their respective distance to the meal seeker. In the case where the networked device is equipped with a GPS receiver, the location of a meal seeker is determined dynamically in real time. Consequently, search results delivered to the meal seeker will also be updated dynamically in real time. Alternative, a meal seeker can select or enter a location or address and search results will be based on the specified location or address only.

At step 140, the meal seeker browses through the result on a networked device and selects a meal option. The selected is then transmitted to the remote server via network connection. In some embodiments, the meal seeker may select more than one meal options that are closely located to each other so that he or she can pick up a few dishes.

At step 150, a meal provider associated with the selected meal option will be notified. In some embodiments, when the meal seeker is open to having dining companions. The meal provider may send an optional dining invitation. In some embodiments, the meal provider may invite multiple meal seekers to join a group dining experience.

At step 160, a final confirmation will be sent to the meal seeker with instructions for picking up the cooked meal. In some embodiments, the instructions include an optional invitation to the meal seeker for joining an on-site dining experience.

Optionally, at steps 102 and 104, database of meal providers and meal seekers can be established. In some embodiments, the database is established using information submitted by a meal provider or meal seeker. In some embodiments, the database is established based on past requests of a meal seeker. In some embodiments, the database is established based on reviews from past meal seekers of a particular meal provider.

In one aspect, methods and systems for creating and maintaining profiles for meal seekers and meal providers are also disclosed.

FIG. 2C illustrate how profiles can be created on the remoted server based on information passed from a meal seeker or meal provider to the remote server. In most embodiments, a remote data server 20 as depicted in FIG. 2C comprises a contact database 354 (e.g., for storing contact lists for all meal seekers and meal providers), a past request database 358 for storing information associated with past meal requests, feedback from meal seekers concerning meals requested including reviews of meal providers, and feedback of meal providers about meal seeker (e.g., whether the meal seeker is a good dining guest), and a profile database 360 which contains information about food-related preferences of meal seekers and cooking specialty of meal providers.

A meal seeker can create a profile by registering with the remote data server via an interface on a networked device. The interface can be part of a mobile app or part of a web page on a browser. A meal seeker profile is associated with a payment method; such as a PayPal account, a credit card, a bank account or any other type of payment option. In some embodiments, a meal seeker can define more food or food-related preferences by making selections on a pre-determined questionnaire form. In some embodiments, a meal seeker can further define food or food-related preferences by following and answering on-screen questions presented in the interface on a networked device. In some embodiment, a meal seeker profile also includes feedback information from a meal provider; for example, whether the meal seeker is a good dining guest. In some embodiments, food or food-related preferences can be added automatically by the system based on past meal requests made by the meal seeker, which will be explained in greater details below.

In some embodiments, a meal seeker can invite a friend to join the system. In some embodiments, it is also possible for meal seekers to share past meal requests or to recommend particular meal providers to each other based on past experience.

A meal provider can also create a profile by registering with the remote data server via an interface on a networked device. The interface can be part of a mobile app or part of a web page on a browser. In some embodiments, a meal provider can define his or her food expertise by making selections on a pre-determined questionnaire form. In some embodiments, a meal provider can further define his or her food expertise by following and answering on-screen questions presented in the interface on a networked device. In some embodiment, a meal provider profile also includes feedback information from a meal seeker; for example, a meal seeker can review the dishes prepared by a meal provider and give the meal provider a star rating. In some embodiments, the food expertise can be further defined automatically by the system based on past meal requests made by the meal seeker (e.g., the number of requests received or the type of cuisines requested), which will be explained in greater details below.

In some embodiments, a meal provider can upload images of meals into his or profile. Separately, a meal seeker can also upload images of meals prepared by a meal provider, for example, as part of the review of the meal.

In some embodiments, a meal provider who would like to host one or more meal seekers for an on-site dining experience. In some embodiments, the meal provider can upload images of his or her dining room.

In one aspect, disclosed is a computer system for implementing the methods of the current invention.

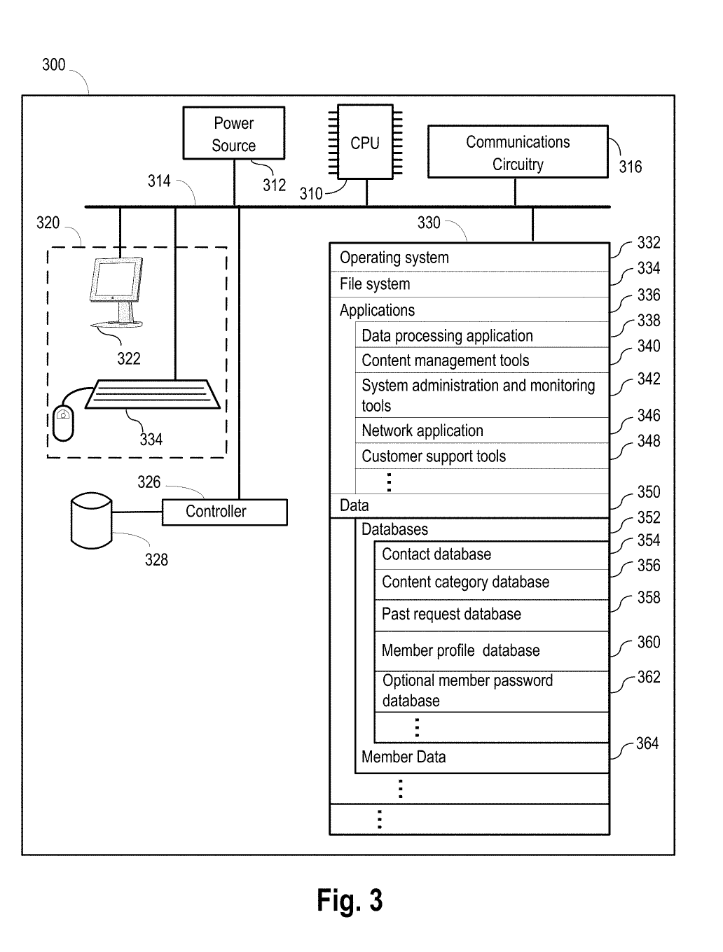

A more complete depiction of an exemplary remote data server is shown in FIG. 3 and discussed below. FIG. 3 illustrates a more detailed exemplary system for a remote data server 300 that supports the functionality described above and detailed in sections below.

In some embodiments, remote data server 300 may comprise a central processing unit 310, a power source 312, a user interface 320, communications circuitry 316, a bus 314, a controller 326, an optional non-volatile storage 328, and at least one memory 330.

Memory 330 may comprise volatile and non-volatile storage units, for example random-access memory (RAM), read-only memory (ROM), flash memory and the like. In preferred embodiments, memory 330 comprises high-speed RAM for storing system control programs, data, and application programs, e.g., programs and data loaded from non-volatile storage 328. It will be appreciated that at any given time, all or a portion of any of the modules or data structures in memory 330 can, in fact, be stored in memory 328.

User interface 320 may comprise one or more input devices 324, e.g., keyboard, key pad, mouse, scroll wheel, and the like, and a display 322 or other output device. A network interface card or other communication circuitry 316 may provide for connection to any wired or wireless communications network, which may include the Internet and/or any other wide area network, and in particular embodiments comprises a telephone network such as a mobile telephone network. Internal bus 314 provides for interconnection of the aforementioned elements of centralized data server 300.

In some embodiments, operation of centralized data server 300 is controlled primarily by operating system 332, which is executed by central processing unit 310. Operating system 332 can be stored in system memory 330. In addition to operating system 332, a typical implementation system memory 330 may include a file system 334 for controlling access to the various files and data structures used by the present invention, one or more application modules 336, and one or more databases or data modules 350.

In some embodiments in accordance with the present invention, applications modules 336 may comprise one or more of the following modules described below and illustrated in FIG. 3.

Data Processing Application 338.

In some embodiments in accordance with the present invention, a data processing application 338 receives and processes contents shared between client devices and between a client device and the remote data server. For example, identifiers of the contents transferred between client devices are sent and stored to the remote data server 300, thereby forming a past request database 358. Sharing records of each member in the meta-community of members are delivered to remote data server 300 from networked devices 10. The sharing records, once received, are processed to extract the essential features to generate templates of sharing data to be used as bases in predicting sharing preference profiles (i.e., profiles with sharing interests) for each member. In some embodiments, sharing records contain identifiers (e.g., web URLs) of the contents that are shared between client devices. In some embodiments, when more complex data are shared between client devices, additional tools may be necessary to extract information from the shared contents to allow a sharing preference profile be created for the members who send the contents. In some embodiments, a hash function is used to perform the information extraction.

In some embodiments, contents received by members may also be used to determine the sharing preference profiles. In preferred embodiments, contents received by a member are considered passive sharing records and therefore will not be given the same weight as the contents sent by the same member.

By applying computation techniques (e.g., hash functions), data processing application 338 turns raw contents shared between members into digital data to construct one or more past request database (e.g., 358).

In some embodiments, data processing application 338 utilizes a chromosome-like systems and methods for determining meal seeker/meal provider characteristics.

In some embodiments, data processing application 338 utilizes a clustering method for determining meal seeker/meal provider characteristics.

The methods and systems are provided by way of illustration only. They should in no way limit the scope of the present invention.

Content Management Tools 340.

In some embodiments, content management tools 340 are used to organize different forms of content databases 352 into multiple databases, e.g., a contact database 354, a content category database 356, a past request database 358, a profile database 360, and an optional user password database 362. In some embodiments in accordance with the present invention, content management tools 340 are used to search and compare any of the databases hosted on the remote data server 300. Contents in accordance with the invention may be a text message, a URL, a web link, a note message, a post message, a file, an image, an audio file, a video file, a flash file, a media file, a slideshow file, or any printable file.

The databases stored on remote data server 300 comprise any form of data storage system including, but not limited to, a flat file, a relational database (SQL), and an on-line analytical processing (OLAP) database (MDX and/or variants thereof). In some specific embodiments, the databases are hierarchical OLAP cubes. In some embodiments, the databases each have a star schema that is not stored as a cube but has dimension tables that define hierarchy. Still further, in some embodiments, the databases have hierarchy that is not explicitly broken out in the underlying database or database schema (e.g., dimension tables are not hierarchically arranged). In some embodiments, the databases in fact are not hosted on remote data server 300 but are in fact accessed by centralized data server through a secure network interface. In such embodiments, security measures such as encryption is taken to secure the sensitive information stored in such databases.

System Administration and Monitoring Tools 342.

In some embodiments in accordance with the present invention, system administration and monitoring tools 342 administer and monitor all applications and data files of remote data server 300. Because privacy data such as sharing records are stored on remote data server 300, it is important that access those files that are strictly controlled and monitored. System administration and monitoring tools 342 determine which servers or devices have access to remote data server 300. In some embodiments, security administration and monitoring is achieved by restricting data download access from remote data server 300 such that the data are protected against malicious Internet traffic. In some embodiments, system administration and monitoring tools 342 use more than one security measure to protect the data stored on remote data server 300. In some embodiments, a random rotational security system may be applied to safeguard the data stored on remote data server 300.

Network Application 346.

In some embodiments, network applications 346 connect a remote data server 300 multiple network services. Referring to FIG. 1, a remote data server 300 is connected to multiple types of client devices, which requires that remote data server be adapted to communications based on different types of network interfaces, for example, router based computer network interface, switch based phone like network interface, and cell tower based cell phone wireless network interface, for example, an 802.11 network or a Bluetooth network. In some embodiments in accordance with the present invention, upon recognition, a network application 346 receives data from intermediary gateway servers before it transfers the data to other application modules such as data processing application 338, content management tools 340, and system administration and monitoring tools 342.

Customer Support Tools 348.

Customer support tools 348 assist users with information or questions regarding their accounts, technical support, billing, etc. In some embodiments, customer support tools 348 may allow a member to manually input or select her interest category to facilitate better characterization of her sharing preference profile.

In some embodiments, each of the data structures stored on remote data server 300 is a single data structure. In other embodiments, any or all such data structures may comprise a plurality of data structures (e.g., databases, files, and archives) that may or may not all be stored on remote data server 300. The one or more data modules 350 may include any number of databases 352 organized into different structures (or other forms of data structures) by content management tools 340.

In addition to the above-identified modules, data 350 may be stored on remote data server 300. Such data comprises content databases 352 and member (e.g., a meal seeker or a meal provider) data 364. Exemplary databases 352 include contact database 354, content category database 356, past request database 358, member (e.g., a meal seeker or meal provider) profile database 360, and optional password dataset 362, which are described below in more details.

Contact Database 354.

For every member in the meta-community, a contact list is established to include all network identifiers and the owners/users of the network identifiers with whom the member has communicated. As described in the member registration process in Section 5.5 in some embodiments, a contact list for the member may be created automatically, for example, by importing existing online address books associated with the member including but not limited to a gmail address book, a Yahoo! Mail address book, a hotmail address book, an IM address book, an outlook address book, a msn address book, Mac OS X address book, or a Windows address book. Alternatively, a contact list can be generated from an online email address book, an online chat address book, an online messenger address book, an email program address book, or an operating system address book.

In some embodiment, a contact list in accordance with the present invention is a sum of all online address books associated with the particular member. In some embodiments, the contact list is organized alphabetically by the names of the owners/users of the network identifiers. In other embodiments, the contact list is organized by category and sorted by types, for example, as email address, IM identifiers, phone numbers, etc. In some embodiments, the contact lists of all members in the meta-community of members are organized into a searchable database (e.g., contact database 354 in FIGS. 2C and 3). In some embodiments, contact database 354 is stored on and managed by programs of remote data server 300. In some embodiment, contact database 354 may be searched by a data processing application 338. In some embodiments, contact database 354 may be maintained, updated and managed by content management tools 340. Each time, a new network identifier is inputted by the member, the contact list associate with the member will be updated. Contact database 354 will also be updated accordingly.

Content Category Database 356.

In some embodiments, remote data server 300 hosts a content category database 356. Content category database 356 contains categorized information of all types of contents that may possibly be shared in accordance with the present invention. In some embodiments, past requests from a meal seeker may be used to analyze based on the content category database 356. In some embodiments, the categorized contents in content category database 356 are represented by one or more identifiers, such as cuisine type, flavor, taste and quantity. Once categorized, the contents may be used to deduce possible food preferences of the meal seeker who made the previous meal requests. In some embodiments, a member's interests may be deduced by matching contents shared by the member with categorized contents in content category database 356.

Past Request Database 358.

In some embodiments, all past requests made by meal seekers are submitted to remote data server 300. In some embodiments, the past requests will be only stored for a period of time. In some embodiments, content management tools 340 may be employed to update the requests. In some embodiments, partial or complete collection of the past requests associated with a meal seeker may be provided to the meal seeker (e.g., in an archive format). In some embodiments, the meal seeker will able to delete the past request records or share the past request with friends as recommendations or suggestions.

Member Profile Database 360.

In some embodiments, at least a profile will be created for each meal seeker. In each profile, information such as food preference or food allergy will be included. In some embodiments, such preferences are determined based on a plurality of past request of the particular meal seeker. In some embodiments, such preferences are determined based on all past request records of the particular meal seeker through an automated learning program that analyzes meal requests and predicts, determines, or updates meal seeker profiles according to the analyses. In preferred embodiments, the automated learning program is located on remote server. Alternatively, a meal seeker or meal provider profile may be defined by the meal seek or provider personally, for example, by filling out questionnaires when she registers to use the service provided by the disclosed system. In some embodiments, a meal seeker or meal provider may manually select items on a list of interests to create a profile.

In some embodiments, the automated learning program utilizes a chromosome-like systems and methods for determining meal seeker/meal provider characteristics.

In some embodiments, the automated learning program utilizes information determined by data processing application 338 and content management tools 340.

In some embodiments, the automated learning program utilizes a clustering method for determining meal seeker/meal provider characteristics.

In some embodiments, a meal seeker or meal provider can set security/privacy settings to instruct the system when and how to perform the automated preference learning process. This may include the ability to tell the system to temporarily or permanently stop monitoring the request activities of a particular meal seeker. In some embodiments, a combination of two or more of the above-mentioned methods is used to define a meal seeker or meal provider preference profile. In some embodiments, all preference profiles are compiled to form a searchable database: profile database 360.

The methods and systems are provided by way of illustration only. They should in no way limit the scope of the present invention.

In some embodiments, a hash function is used to extract information from past requests of a meal seeker or reviews of a meal providers. A hash function (or hash algorithm) is a reproducible method of turning data (usually a message or a file) into a number suitable to be handled by a computer. Hash functions provide a way of creating a small digital “fingerprint” from any kind of data. The function chops and mixes (e.g., bit shifts, substitutes or transposes) the data to create the fingerprint, often called a hash value. The hash value is commonly represented as a short string of random-looking letters and numbers (e.g., binary data written in hexadecimal notation). A good hash function is one that yields few hash collisions in expected input domains. In hash tables and data processing, collisions inhibit the distinguishing of data, making records more costly to find. Hash functions are deterministic. If two hash values derived from two inputs using the same function are different, then the two inputs are different in some way. On the other hand, a hash function is not injective, e.g., the equality of two hash values ideally strongly suggests, but does not guarantee, the equality of the two inputs. Typical hash functions have an infinite domain (e.g., byte strings of arbitrary length) and a finite range (e.g., bit sequences of some fixed length). In certain cases, hash functions can be designed with one-to-one mapping between identically sized domain and range. Hash functions that are one-to-one are also called permutations. Reversibility is achieved by using a series of reversible “mixing” operations on the function input. If a hash value is calculated for a piece of data, a hash function with strong mixing property ideally produces a completely different hash value each time when one bit of that data is changed.

Computer System and Program Product

Disclosed methods can be implemented as a computer system and/or a computer program product that comprises a computer program mechanism embedded in a computer readable storage medium. Further, any of the methods of the present invention can be implemented in one or more computers or computer systems. Further still, any of the methods of the present invention can be implemented in one or more computer program products. Some embodiments of the present invention provide a computer system or a computer program product that encodes or has instructions for performing any or all of the methods disclosed herein. Such methods/instructions can be stored on a CD-ROM, DVD, magnetic disk storage product, or any other computer readable data or program storage product. Such methods can also be embedded in permanent storage, such as ROM, one or more programmable chips, or one or more application specific integrated circuits (ASICs). Such permanent storage can be localized in a server, 802.11 access point, 802.11 wireless bridge/station, repeater, router, mobile phone, or other electronic devices. Such methods encoded in the computer program product can also be distributed electronically, via the Internet or otherwise, by transmission of a computer data signal (in which the software modules are embedded) either digitally or on a carrier wave.

Some embodiments of the present invention provide a computer system or a computer program product that contains any or all of the program modules as disclosed herein. These program modules can be stored on a CD-ROM, DVD, magnetic disk storage product, or any other computer readable data or program storage product. The program modules can also be embedded in permanent storage, such as ROM, one or more programmable chips, or one or more application specific integrated circuits (ASICs). Such permanent storage can be localized in a server, 802.11 access point, 802.11 wireless bridge/station, repeater, router, mobile phone, or other electronic devices. The software modules in the computer program product can also be distributed electronically, via the Internet or otherwise, by transmission of a computer data signal (in which the software modules are embedded) either digitally or on a carrier wave.

In preferred embodiments, the disclosed methods are implemented in a mobile device interface (app) developed in all the major platforms: Android, IOS, Windows mobile, etc.

Having described the invention in detail, it will be apparent that modifications, variations, and equivalent embodiments are possible without departing the scope of the invention defined in the appended claims. Furthermore, it should be appreciated that all examples in the present disclosure are provided as non-limiting examples.

### EXAMPLES

The following non-limiting examples are provided to further illustrate embodiments of the invention disclosed herein. It should be appreciated by those of skill in the art that the techniques disclosed in the examples that follow represent approaches that have been found to function well in the practice of the invention, and thus can be considered to constitute examples of modes for its practice. However, those of skill in the art should, in light of the present disclosure, appreciate that many changes can be made in the specific embodiments that are disclosed and still obtain a like or similar result without departing from the spirit and scope of the invention.

### Example 1

### Meal Seeker Profile Interface

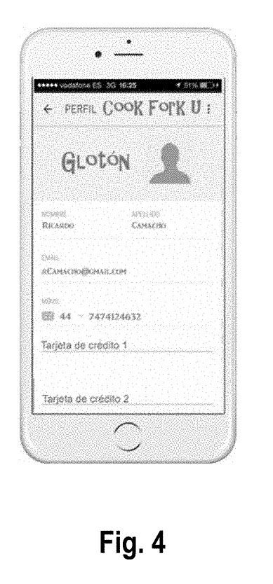

FIG. 4 depicts an exemplary meal seeker profile interface. The profile tag “Cook Fork U” indicates that this is the profile of a meal seeker. The meal seeker's name and contact information (e.g., email and phone number) are included.

### Example 2

### Meal Provider Profile Interface

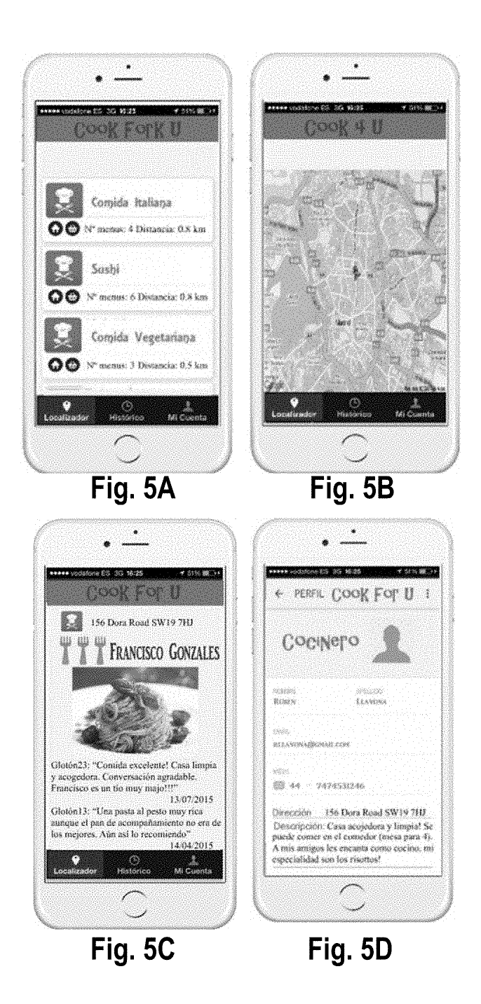

FIGS. 5A-5C illustrates how a meal provider can be presented to potential meal seekers. In FIG. 5A, a meal seeker can flip through a list of meal providers by their specialties and numeric distance from the meal seeker.

In FIG. 5B, a meal seeker can view a map where one or more meal provider is location. The map can also provide directions to the meal seeker on how to get to the meal provider's location.

FIG. 5C shows an exemplary profile page of a meal provider. The page includes a tag “Cook For U,” which identifies that this is the profile of a meal provider. The page also includes the address of the meal profile, a picture of a dish prepared by the meal provider, as well as multiple reviews from meal seekers who have previously requested this dish from the particular meal provider.

FIG. 5D shows an exemplary profile page, which includes the contact information of the meal provider.

The various methods and techniques described above provide a number of ways to carry out the invention. Of course, it is to be understood that not necessarily all objectives or advantages described may be achieved in accordance with any particular embodiment described herein. Thus, for example, those skilled in the art will recognize that the methods can be performed in a manner that achieves or optimizes one advantage or group of advantages as taught herein without necessarily achieving other objectives or advantages as may be taught or suggested herein. A variety of advantageous and disadvantageous alternatives are mentioned herein. It is to be understood that some preferred embodiments specifically include one, another, or several advantageous features, while others specifically exclude one, another, or several disadvantageous features, while still others specifically mitigate a present disadvantageous feature by inclusion of one, another, or several advantageous features.

Furthermore, the skilled artisan will recognize the applicability of various features from different embodiments. Similarly, the various elements, features and steps discussed above, as well as other known equivalents for each such element, feature or step, can be mixed and matched by one of ordinary skill in this art to perform methods in accordance with principles described herein. Among the various elements, features, and steps some will be specifically included and others specifically excluded in diverse embodiments.

Although the invention has been disclosed in the context of certain embodiments and examples, it will be understood by those skilled in the art that the embodiments of the invention extend beyond the specifically disclosed embodiments to other alternative embodiments and/or uses and modifications and equivalents thereof.

Many variations and alternative elements have been disclosed in embodiments of the present invention. Still further variations and alternate elements will be apparent to one of skill in the art.

In some embodiments, the numbers expressing quantities of ingredients, properties such as molecular weight, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

In some embodiments, the terms “a” and “an” and “the” and similar references used in the context of describing a particular embodiment of the invention (especially in the context of certain of the following claims) can be construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

In closing, it is to be understood that the embodiments of the invention disclosed herein are illustrative of the principles of the present invention. Other modifications that can be employed can be within the scope of the invention. Thus, by way of example, but not of limitation, alternative configurations of the present invention can be utilized in accordance with the teachings herein. Accordingly, embodiments of the present invention are not limited to that precisely as shown and described.

What is claimed is:

1. A method for providing a cooked meal to a meal seeker, comprising:
receiving, at a remote server, a meal request from a meal seeker, wherein the meal request is sent via an interface on a networked device and comprises one or more food preferences;
delivering, from the remote server, one of more available meal options to the meal seeker via the interface on the networked device;
receiving, at the remote server, a selection among the one of more available meal options from the meal seeker;
communicating the selected meal option to a meal provider of the selected meal option; and
sending a confirmation to the meal seeker with instructions for obtaining the selected meal option.

2. The method of claim 1, wherein the one or more food preferences are selected from the group consisting of location, cuisine type, price, time preference, take-out option, dining option, and food allergy information.

3. The method of claim 1, wherein the one or more available meal options are generated based on the meal request from the meal seeker.

4. The method of claim 1, wherein the meal request is created using a menu in the interface on the networked device.

5. The method of claim 1, wherein the meal seeker has a meal seeker profile stored on the remote server.

6. The method of claim 1, wherein the meal provider is within a predefined physical vicinity to the meal seeker.

7. The method of claim 1, wherein the meal provider has a meal provider profile stored on the remote server.

8. The method of claim 1, wherein the remote server includes one or more selected from the group consisting of a database of meal options, a database of meal seekers, and a database of meal providers.

9. The method of claim 1, wherein the one or more available meal options are ranked based on one selected from the group consisting of physical vicinity to the meal seeker, price, and reviews of a meal provider.

10. The method of claim 1, wherein instructions comprise an optional invitation to dine with the meal provider.

11. The method of claim 1, wherein the networked device is selected from the group consisting of a desktop computer, a laptop computer, a cellular phone, a personal digital assistant (PDA), an iPod, a tablet, a mobile device equipped with a network device, a smart phone, a pager, a television, a media player, a digital video recorder (DVR), and any other networked devices.

12. A method for obtaining a cooked meal from a meal provider, comprising:
sending, via an interface on a networked device and to a remote server, a meal request, wherein the meal request comprises one or more food preferences;
receiving, via the interface and from the remote server, one or more available meal options;
sending, via the interface and to the remote server, a selected meal option from the one or more available meal options; and
receiving, via the interface and from the remote server, a confirmation including instructions for obtaining the selected meal option.

13. The method of claim 12, further comprising:
selecting, via the interface, a meal option among the one or more available meal options.

14. The method of claim 12, wherein the one or more food preferences are selected from the group consisting of location, cuisine type, price, time preference, take-out option, dining option, and food allergy information.

15. The method of claim 12, wherein the meal request is created using a menu in the interface on the networked device.

16. The method of claim 12, wherein the meal request is created using a menu in response to a communication received from the remote server via the interface on the networked device.

17. The method of claim 12, wherein the meal seeker has a meal seeker profile stored on the remote server.

18. The method of claim 12, wherein the remote server includes a database of meal options.

19. The method of claim 12, wherein the one or more available meal options are ranked based on one selected from the group consisting of physical vicinity to the meal seeker, price, and reviews of a meal provider.

20. The method of claim 12, wherein the networked device is selected from the group consisting of a desktop computer, a laptop computer, a cellular phone, a personal digital assistant (PDA), an iPod, a tablet, a mobile device equipped with a network device, a smart phone, a pager, a television, a media player, a digital video recorder (DVR), and any other networked devices.

21. A method of providing a cooked meal to a meal seeker, comprising:
receiving, via an interface on a networked device and from a remote server, a meal request, wherein the meal request specifies one or more food preferences;
sending, via the interface and to the remote server, a communication, wherein the communication includes a price; and
receiving, via the interface and from the remote server, a confirmation whether the communication is accepted by the meal seeker.

22. The method of claim 21, wherein the communication further comprises an optional dining invitation to the meal seeker.

23. The method of claim 21, wherein the one or more food preferences are selected from the group consisting of location, cuisine type, price, time preference, take-out option, dining option, and food allergy information.
